(19) United States
(12) Patent Application Publication
(10) Pub. No.: US 2002/0135535 A1
(43) Pub. Date: Sep. 26, 2002

(54) Portable electronic data processing device

(76) Inventor: Alexander Muller, Auerbach (DE)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 09/795,663

(22) Filed: Feb. 28, 2001

(30) Foreign Application Priority Data
Jan. 20, 2001 (DE) 101 02 518.1

(51) Int. Cl. G09G 5/00

(52) U.S. Cl. 345/1.1

(57) ABSTRACT

The invention relates to a portable electronic data processing device, in particular a portable computer. The device includes a central unit which has a processor and a memory. Furthermore, the device includes an input device. The output device has an optical output unit in the form of a screen as an integral component of the data processing device. According to the invention it is provided that the optical output unit has at least one additional separate screen (26, 28, 30) which is formed, at least in a usable state, as an integral component of the portable electronic data processing device.

### DESCRIPTION

The invention relates to a portable electronic data processing device, in particular a portable computer according to the preamble of claim 1.

With a portable electronic data processing device or a portable computer nearly all those uses are possible which are possible at stationary facilities. Portable computers can be connected to a network, for example, telephone, internet, or the like so that a practically unlimited amount of data is available. Furthermore, portable computers have a very high storage capacity so that very large amounts of data are also available directly. The data can be output optically as well as acoustically. A screen, display, or the like is preferably used, along with the printer, as an optical output device.

Numerous professional groups use a portable computer in their field service in order thereby to present their products and/or services with respect to customers, clients, or the like. In this situation the portable computer can be used as an electronic catalog or prospectus. Furthermore, products or services can be planned or calculated according to customer-specific parameters.

Traditional portable computers are, however, unsuitable for sales or consulting meetings. Customarily in a sales meeting the supplier and the potential customer sit essentially opposite one another. This has a positive effect on the atmosphere of the meeting. With the use of traditional portable computers it is on the contrary required that both sit or stand directly next to one another in order to be able to see the optical output device of the computer. Bodily proximity of this type is undesirable for most people. Thus, traditional portable computers have a negative effect on the atmosphere of the meeting.

Furthermore, computers are often used as amusement devices. An extensive software offering is available on the market. Traditional computers are merely suitable for those games which are conceived for a single participant. In contradistinction to this, a seating arrangement is provided for games with two or more participants in which the participants sit opposite one another. For such computer games traditional computers are unsuitable.

It is thus the objective of the invention to provide a portable electronic data processing device which makes it possible for two or more persons sitting opposite one another or at a distance from one another to simultaneously see information output optically.

This objective is realized by the features of claim 1.

According to claim 1, it is provided that the optical output unit has at least one additional separate screen which is formed, at least in a usable state, as an integral component of the portable electronic data processing device.

Thereby different persons or groups of persons can be assigned to different screens. Thereby customary seating arrangements can be taken into account. The positioning of the separate screens can be adapted to the geometric contingencies in a particular case.

In particular it is provided that the at least two screens are disposed in such a way that they can be seen from essentially opposite sides. With such a device, in particular, sales or consulting meetings between suppliers and customers can be carried out. Therein the participants can sit opposite one another, which is an important prerequisite for a pleasant atmosphere in the meeting. At least one screen is assigned to the participants which is preferably in their central field of vision. In a particularly preferred development, different information is made available to the persons positioned separated from one another. In a sales meeting the customer has, for example, view of that information which is customarily contained in a sales prospectus. The salesperson on the contrary can access, in addition, information internal to the company, such as, for example, sales prices, inventory, or the like. Furthermore, those games can be simulated with a device according to the invention in which one player may not see the cards or the game plan of the opposing player.

Furthermore, it can be provided that the optical output unit has a central and two lateral screens. With a device of this type, for example, three-dimensional representations can be simulated. Expediently the two lateral screens can be coupled to the central screen via a hinge. Thereby the entire device can be folded together into a portable format. Ideally, the two lateral screens together have the same surface area as the central screen. Thereby the ratio between transport size and presentation size is optimized.

Furthermore, it can be provided that the separate screens can be controlled by the input device independently of one another. Thereby different data can be output via the separate screens. For many suppliers, that is, salespersons, consultants, representatives, or the like, it is desirable that not all the information can be seen by their counterpart. In this way internal information can be processed discreetly.

However, the idea of the invention also includes not only realizations in which persons or groups of persons are placed at a position from which the user screen cannot be seen, but rather realizations are also conceivable in which persons or groups of persons are placed left and right of the user screen where, for example, additional screens (lateral screens) can be disposed to the side of the user screen, preferably so that they can be swiveled. These additional screens can be brought into a position in which each of their directions of radiation is aligned to the side, for example at a 60° angle or 90° angle to the direction of radiation of the user screen.

The user screen and/or the additional separate screens can be hingedly connected to adjacent screens or to the housing of the central unit so that they can be pivoted, in given cases even about each of two different pivot axes. In one development, which is even claimed independently of the present claim 1, merely a single screen is hingedly connected to the portable electronic data processing device so that it can be pivoted about two different axes, preferably perpendicular to one another. In this case the screen can, if needed, even be pivoted alternately between at least two persons or groups of persons.

The utilization of a data processing device with several integrated screens in the usable state is not restricted to pivotable or plug-in connectors. Rather, it is also conceivable to configure or dispose an internal screen so that is can be pulled out from the housing of an external screen or from the housing of the central unit.

In the aforementioned forms of embodiment there is furthermore the possibility of combining a plurality of separate screens in the traditional format into a single large screen. In this case the individual screens can be coupled to one another via hinges or via plug-in connectors. Thereby a large presentation screen can be provided on the one hand while a transportable format can be achieved on the other hand. This can be used in particular at presentations, conferences, and the like.

Additional features, particular forms of embodiment, and advantages of the invention are the object of the subordinate claims.

Below several particular forms of embodiment of the invention are explained in more detail with the aid of drawings. Shown are:

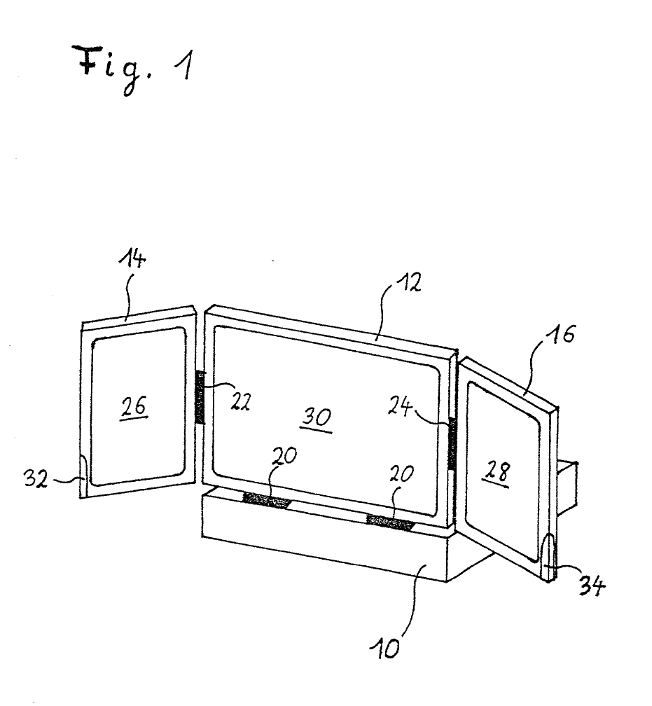

FIG. 1 a preferred form of embodiment of the device according to the invention;

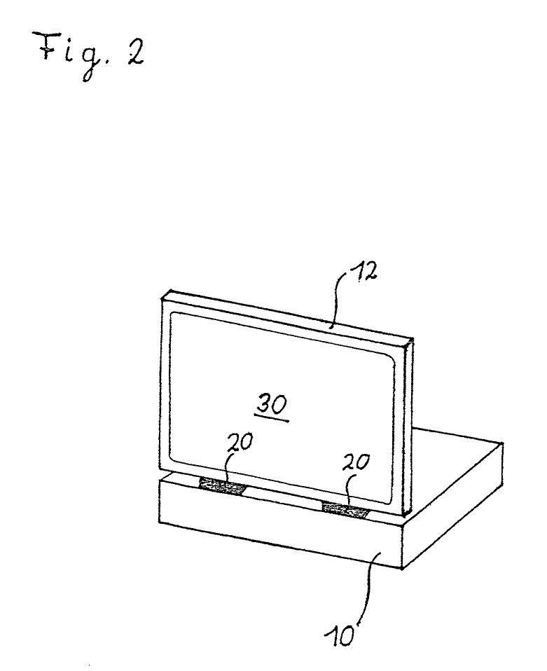

FIG. 2 a cost-effective form of embodiment of the device according to the invention;

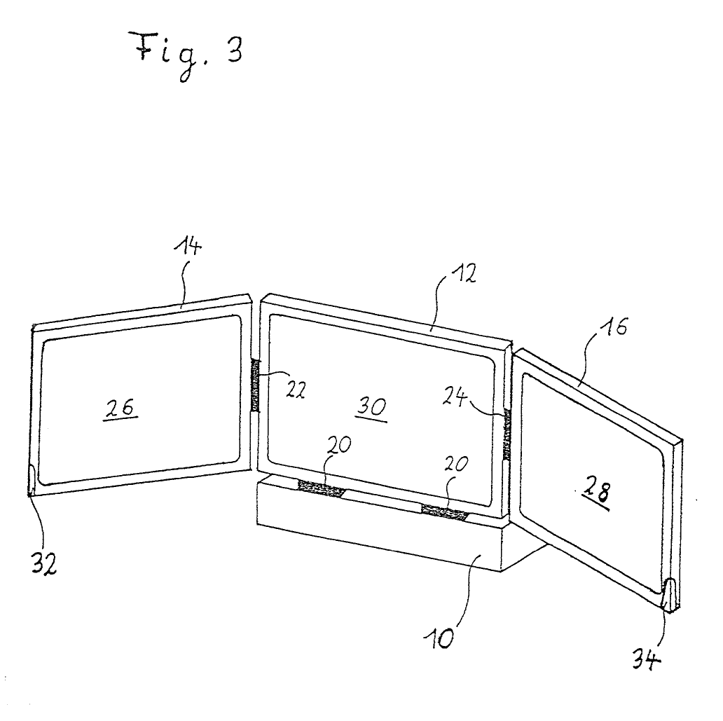

FIG. 3 a form of embodiment of the device according to the invention for the presentation of especially wide images;

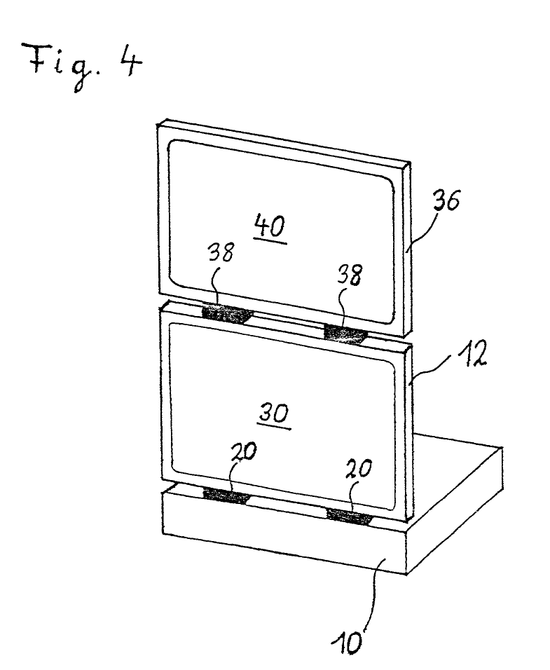

FIG. 4 a form of embodiment of the device according to the invention for especially high images;

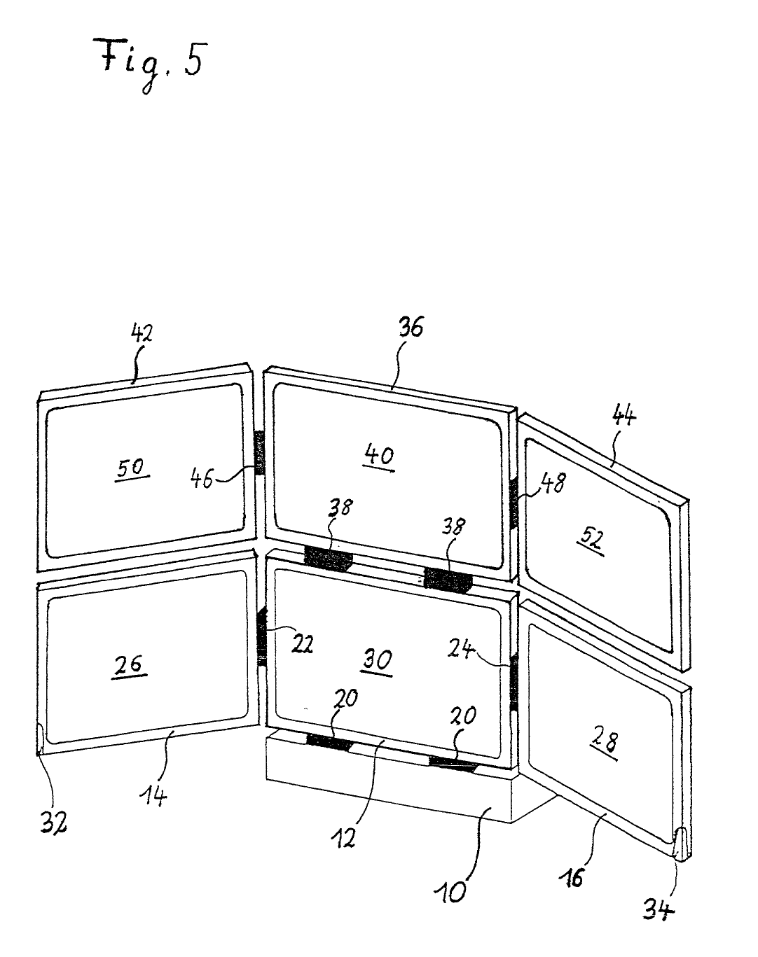

FIG. 5 a form of embodiment of the device according to the invention for especially large-surface images.

In FIG. 1, the portable computer according to the invention is represented in the folded-out state. The portable computer includes a main part 10, an upper part 12, and two lateral parts 14 and 16. The main part 10, upper part 12, and the lateral part 14 and 16 are formed to be flat. In particular, a microprocessor, a memory, interfaces, a hard disk as mass storage, and drives for additional storage media are integrated into the main part 10. The upper side of the main part 10 includes a keyboard as an input device. The main part 10 and the upper part 12 are coupled to one another by means of two hinges 20. In both the main part 10 and the upper part 12 the hinges 20 are mounted on a longitudinal edge. The lateral part 14 is coupled to the upper part 12 via a hinge 22. The lateral part 16 is coupled to the upper part 12 via a hinge 24. The hinges 22 and 24 are located on opposite edges of the upper part 12.

A user screen, which is not visible in the drawing, is integrated into the upper part 12 on the side facing the keyboard. A presentation screen 30 is integrated into the opposite side of the upper part 12. A latex foil screen 26 or 28 is integrated into each of the lateral parts 14 and 16 respectively. All four screens are preferably formed in the so-called TFT technology. In that case it is provided that common TFT circuits are assigned to the screens. This is particularly advantageous for reasons of space and cost. Furthermore, integrated into the lateral parts 14 and 16, there are loudspeakers 32 and 34 whose direction of radiation is adapted to the alignment of the presentation screen 30 and the lateral screens 26 and 28.

The screens are disposed so that in the folded-up state of the portable computer the user screen and the two lateral screens 26 and 28 are directed downwards while the presentation screen 30 is directed upwards. Furthermore, in the folded-up state the user screen and the keyboard lie on one another. Likewise, the presentation screen 30 and the two lateral screens 26 and 28 lie on one another. Thus in the folded-up state none of the screens is located on the outer side, whereby all four screens are protected. The hinges can be formed so that an angular range of nearly 360° can be selected.

In the folded-up state the upper part 12 and the lateral parts 14 and 16 are disposed so that the keyboard and the user screen can be seen by a user. The presentation screen 30 and the two lateral screens 26 and 28 on the contrary cannot be seen by the user. Conversely, the presentation screen 30 and the two lateral screens 26 and 28 can be seen by a person sitting opposite the user but neither the keyboard nor the user screen can be seen by the person sitting opposite the user. The user screen on the one hand and the presentation screen 30 and the two lateral screens 26 and 28 on the other hand are separately controllable. Thereby the user can, for example, output to the user screen data which are intended solely for her/him and are not visible to the person sitting opposite. Likewise, there is the possibility that the user screen and the presentation screen 30 are controlled in common with the same data. In this mode of operation the two parties to the conversation, sitting opposite one another, have a view of the same screen contents at the same time. Along with this the screen contents of the user screen can be distributed on the presentation screen 30 and the two lateral screens 26 and 28. The aforementioned modes of operation are selectable via software so that no modifications in the hardware are required for a change of modes.

Furthermore, three-dimensional effects can be simulated with the presentation screen 30 and the two lateral screens 26 and 28. In this case the hinges 22 and 24 are set so that the planes of the presentation screen 30 and the two lateral screens 26 and 28 make an oblique angle. Audio signals can be output in stereo over the two loudspeakers 32 and 34. Thus audio-visual presentation of products and/or services is possible which is effective in advertising.

With the data processing device, the invention possibilities of use which can be carried out with traditional portable computers are widened. In a sales or consulting meeting, suppliers and customers, sitting opposite one another, see the same screen contents with only one computer. Alternatively, the user can prepare different screen contents for him/herself and for the customers.

Alternatively, the data processing device according to the invention can also be embodied without the lateral parts 14 and 16 and the lateral hinges 26 and 28. In FIG. 2 a device of this type is represented. This form of embodiment also has a main part 10, an upper part 12, and two hinges 20. A presentation screen 30 is integrated into the upper part 12. In the folded-up state of the device the presentation screen 30 is disposed on the outer side. A loudspeaker can be integrated into the main part 10 and/or into the upper part 12. This alternative form of embodiment (according to FIG. 2) represents a particularly cost-effective version of the device according to the invention which also offers the essential aforementioned advantages.

An additional form of embodiment of the device according to the invention with particularly broad lateral parts 14 and 16 and lateral screens 26 and 28 is represented in FIG. 3. In this form of embodiment the two lateral screens 26 and 28 have approximately the same format as the presentation screen 30. In the folded-up state of the device the lateral parts 14 and 16 are disposed over one another. In contradistinction thereto, in the device according to FIG. 1 the lateral parts 14 and 16 are disposed next to one another in the folded-up state. The folding up of the device is preferably done by first folding the main part 10 and the upper part 12 onto one another and subsequently the lateral parts 14 and 16 being folded one after the other against the upper part 12. The device according to FIG. 3 is provided in particular for the presentation of so-called panoramic images and the like. In particular, in the form of embodiment according to FIG. 3 in the folded-out state a configuration is offered in which the upper part 12 and the lateral part 14 on the one hand and the upper part 12 and the lateral part 16 on the other hand are approximately at a right angle to one another. Thereby one screen is available on each of the four sides. If, for example, the participants in a meeting are sitting at a rectangular table, then one screen is assigned to each side of the table.

FIG. 4 shows a form of embodiment according to the invention which is formed similarly to that according to FIG. 2. In addition the form of embodiment according to FIG. 4 has an additional upper part 36 which is foldably coupled to the upper part 12 via two hinges 38. The upper part 36 also has a presentation screen 40 which has approximately the same size as the presentation screen 30. In the folded-up state of the device the presentation screen 30 and 40 can be seen from the same side. If the hinges 38 are set so that the two upper parts 12 and 36 lie essentially in one plane, then the presentation screens 30 and 40 together form a single screen in the high format.

FIG. 5 shows a form of embodiment according to the invention which represents a synthesis of the forms of embodiment according to FIG. 3 and FIG. 4. This form of embodiment also has a main part 10 and an upper part 12. The presentation screen 30 is integrated into the upper part 12. The main part 10 and the upper part 12 are foldably coupled via two hinges 20. The upper part 12 is coupled via the hinges 22 and 24 to the lateral parts 14 or 16. A lateral screen 26 is integrated into the lateral part 14 and a lateral screen 28 is integrated into the lateral part 16. The lateral screens 26 and 28 have about the same size as the presentation screen 30. The upper part 12 is foldably coupled via the two hinges 38 to the additional upper part 36.

In addition to the forms of embodiment described above, that according to FIG. 5 has two additional lateral parts 42 and 44. The lateral parts 42 and 44 are foldably coupled to the upper part 36 via two hinges 46 or 48. Additional lateral screens 50 or 52 are integrated into the lateral parts 42 and 44. In the folded-out state the device according to FIG. 5 can be used as a mobile multivision wall. The screens 26, 28, 30, 40, 50, and 52 are approximately equally large and together form a one screen which has about six times the surface area of the surface area of the device in the folded-up state. The device according to FIG. 5 is a means of presenting products and/or services which is effective from the standpoint of advertising.

In the case of all the aforementioned forms of embodiment plug-in connectors can also be used instead of the hinges 20, 22, 24, 38, 46, or 48. The housings are coupled to one another mechanically as well as electrically by means of these plug-in connectors. Also forms of embodiment are possible which have hinges as well as plug-in connectors. For example, the form of embodiment according to FIG. 5 can have between the housings 10, 12, 14, and 16 the hinges 20, 22, and 24 while on the other hand the housings 36, 42, and 44 are mounted by means of plug-in connectors which are used instead of the hinges 38, 46, and 48. In this way a so-called standard model with a presentation screen 30 and two lateral screens 26 and 28 is provided which, if needed, can be expanded with the screens 40, 50, and 52.

Furthermore, a large screen which is composed of a plurality of individual screens can be provided with the use of plug-in connectors. In this way large presentation surfaces on the one hand and a transportable format on the other hand can be achieved. This device is suitable in particular in presentations, conferences, advertising agencies, and the like.

Reference Numbers

| | |
|---|---|
| 10 | Main Part |
| 12 | Upper Part |
| 14 | Lateral Part |
| 16 | Lateral Part |
| 20 | Hinge |
| 22 | Hinge |
| 24 | Hinge |
| 26 | Lateral Screen |
| 28 | Lateral Screen |
| 30 | Presentation Screen |
| 32 | Loudspeaker |
| 34 | Loudspeaker |
| 36 | Additional Upper Part |
| 38 | Hinge |
| 40 | Additional Presentation Screen |
| 42 | Upper Lateral Part |
| 44 | Upper Lateral Part |
| 46 | Hinge |
| 48 | Hinge |
| 50 | Additional Lateral Screen |
| 52 | Additional Lateral Screen |

1. Portable electronic data processing device, in particular a portable computer including:
a central unit which has a processor and a memory,
an input device, and
an optical output unit in the form of a screen as an integral component of the data processing device
characterized by the fact that
the optical output unit has at least one additional separate screen which is formed, at least in the usable state, as an integral component of the data processing device.

2. Device according to claim 1
characterized by the fact that
the at least two screens are disposed in such a way that they can be seen from two different, in particular opposite, sides.

3. Device according to claim 1 or 2
characterized by the fact that
the optical output unit has at least one user screen which can be seen by a user of the input device.

4. Device according to claim 3
characterized by the fact that
the optical output unit has a central screen (30) and two lateral screens (26, 28) which can be seen from one side essentially opposite the input device.

5. Device according to claim 4
characterized by the fact that
to each of the lateral screens (26, 28) a loudspeaker (32, 34) is assigned whose direction of radiation is adapted to that of the presentation screen (30) and the lateral screens (26, 28).

6. Device according to one of the claims 3 to 5
characterized by the fact that
the screens are formed in the so-called TFT technology.

7. Device according to claim 6
characterized by the fact that
a common TFT control circuit is assigned to the screens.

8. Device according to one of the claims 1 to 7
characterized by the fact that
the separate screens can be controlled by the input device independently of one another.

9. Device according to one of the claims 1 to 8
characterized by the fact that
the central screen (30) is disposed on the back side of that screen which can be seen by the user of the input device.

10. Device according to one of the claims 1 to 9
characterized by the fact that
the central unit and the input device are integrated into one housing (10).

11. Device according to one of the claims 9 to 10
characterized by the fact that
the optical output unit (26, 28, 30, 40, 50, 52) is integrated into at least one additional housing (12, 14, 16, 36, 42, 44).

12. Device according to claim 10 or 11
characterized by the fact that
the additional housing (12, 14, 16) is formed as a flat square where one of the screens (26, 28, 30) is integrated into at least one of the two large-surface sides.

13. Device according to one of the claims 1 to 12
characterized by the fact that
the device can be folded up.

14. Device according to claim 13
characterized by the fact that
the housings (10, 12, 14, 16, 36, 42, 44) are foldably coupled via the hinges (20, 22, 24, 38, 46, 48).

15. Device according to claim 13 or 14
characterized by the fact that
in the folded-up state of the device none of the screens (26, 28, 30, 40, 50, 52) is disposed on the outer side.

16. Device according to one of the claims 1 to 12
characterized by the fact that
the device can be folded up.

17. Device according to claim 16
characterized by the fact that
the housings (10, 12, 14, 16, 36, 42, 44) can be coupled mechanically as well as electrically via plug-in connectors.

18. Device according to one of the claims 1 to 12
characterized by the fact that
the device can be collapsed by folding up and can be collapsed by plugging.

19. Device according to one of the preceding claims
characterized by the fact that
a part of the housings (10, 12, 14, 16) are coupled via the hinges (20, 22, 24) and at least one additional housing (36, 42, 44) can be coupled by means of plug-in connectors (38, 46, 48).

20. Device according to one of the preceding claims
characterized by the fact that
the optical output unit has at least one additional separate screen (26, 28, 30, 40, 50, 52) which is coupled, at least in a usable state, via electrical lines and/or the data connection to the central unit and/or the input device.

21. Device according to one of the claims 1 to 20
characterized by the fact that
the device has a plurality of screens (26, 28, 30, 40, 50, 52) which can be combined into a large screen and are controlled as a large screen.
